(19) United States
(12) Patent Application Publication
(10) Pub. No.: US 2006/0257094 A1
(43) Pub. Date: Nov. 16, 2006

(54) Optical co2 and combined o2/co2 sensors

(75) Inventors: Aisling McEvoy, Dublin (IE); Brian MacCraith, Dublin (IE); Colette McDonagh, Dublin (IE); Christoph Von Bultzingslowen, Dublin (IE); Olive Von Bultzingslowen, Dublin (IE)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Gas Sensors Solutions Limited, Glasnevin, Dublin (IE)

(21) Appl. No.: 10/547,065

(22) PCT Filed: Feb. 27, 2004
(86) PCT No.: PCT/IE04/00028

§ 371 Date: Jun. 1, 2006

(30) Foreign Application Priority Data
Feb. 28, 2003 (IE) S2003/0144

(51) Int. Cl. G02B 6/00

(52) U.S. Cl. 385/147

(57) ABSTRACT

Improved carbon dioxide sensors are disclosed which are less sensitive to the moisture content of the environment and which are substantially insensitive to oxygen levels under normal working conditions. The CO₂ sensor comprises a pH indicator and long-lived reference luminophore and a porous sol-gel matrix. Combined CO₂ and O₂sensors are also described. Further disclose are methods of printing sensor onto substrates.

### FIELD OF THE INVENTION

The present invention relates to improved carbon dioxide and oxygen sensors, to a combined carbon dioxide/oxygen sensor, to methods of making the sensors, to the use of such sensors and to methods of applying the sensors onto a substrate.

### BACKGROUND OF THE INVENTION

Carbon dioxide (CO₂) sensors are already known. For example, WO 99/06821 discloses a method and device for the fluorometric determination of a biological, chemical or physical parameter of a sample, using at least two different luminescent materials, the first of which responds to the parameter at least as regards luminescence intensity and the second of which does not respond to the parameter as regards luminescence intensity and decay time. The luminescent materials have different decay times and the time or phase behaviour of the luminescence response obtained is used to generate a reference variable for determining a parameter. This Dual Luminophore Referencing (DLR) is an internal ratiometric method whereby the analyte-sensitive fluorescence intensity signal is converted into the phase domain by co-immobilizing an inert long-lifetime reference luminophore with similar spectral characteristics. Generally speaking a long-lived phosphor is immobilized in a sol-gel and then formed into sintered glass. The sintered glass and a short-lived phosphor are then formed into a polymer matrix with a polymer such as ethyl cellulose polymer.

One problem associated with this type of sensor is that because the sensor is formulated in a polymer matrix, the polymer will swell in a moist environment, which affects the calibration of the sensor and makes the sensor less reliable in moist environments. Furthermore, mechanical strength of a polymer is low in that the material is a rubbery type material rather than a rigid glass-like material like sol-gel, and optical transparency can be poor as polymeric films can be cloudy.

The sensors of the present invention find application in the packaging industry and in particular in areas where the applications require a guarantee of the integrity of the package. Such packages include food packaging in general, and specifically of food exports, particularly of high margin foods e.g. certain fish/shellfish, bulk food ingredients, wine, beer, long term food storage as required for emergency aid and military operations, in the catering industry, pharmaceutical industry and in the packaging of medical disposables, surgical instruments and paediatric products as well as in any sectors that required a clean room manufacturing or assembly environment. The sensors also find use in applications where the atmosphere is critical to the product, such as protective atmospheres for art conservation or gas-sensitive, limited-life products such as DVDs. Other applications include monitoring of water quality, in-line production monitoring and in biofermentation reactors.

Currently used methods of checking the integrity of packages and the possible contamination of sterilised products involve destructive sampling in which a proportion of the packages are opened and tested for damage to the packaging for microbial contamination. However, this method only tests a small proportion of the packages and damaged packages could be present in the much larger proportion of packages not tested. Furthermore, the method destroys packages which may well have been intact and is therefore quite wasteful of both packages and their contents.

Food products are often packed under a protective atmosphere of carbon dioxide. Often, but not always, the exclusion of oxygen is preferred in order to inhibit growth of aerobic spoilage organisms, whereas carbon dioxide is typically used to decrease bacterial growth rates. Because package integrity is an essential requirement for the quality of MAP food, leakage detection is a very important part of MAP technology. The standard method currently used to check the integrity of the modified atmosphere package (MAP) involves the use of a MAP analyser instrument. This involves piecing the package using a needle probe to withdraw a sample of the protective gas atmosphere. The gas is then analysed using an electrochemical sensor to determine the oxygen concentration, and infrared spectrometry to determine the carbon dioxide concentration. As this is a destructive method, only a small percentage of the packages can be tested and so 100% quality control is not possible. Testing normally takes place at the packaging plant and is a validation of the packaging process. If a package is found to be leaking, what follows is a time consuming and costly process of back-checking and repacking. Once the packages leave the processing plant, there is no monitoring of the package integrity or freshness of the food (e.g. PBI-Dansensor MAP Check Combi or Systech Interuments Portamap2 or Gaspac).

Another instrument used to check for leak detection uses non-invasive methods. This involves placing the package into a pressure chamber and checking for leaks using carbon dioxide. It has the advantage of being non-destructive but is time-consuming and would not easily be incorporated into a production line. (e.g. PBI-Dansensor Pack Check).

An optical sensor for oxygen detection has been commercialised recently. It is based on fluorescence lifetime detection of a Ruthenium dye complex. This technology has been developed by OxySense in conjunction with the Sensor Development Department of TNO Voeding, and is being marketed as a Non-Invasive Oxygen Analyser for Food and Beverage Applications. The ruthenium dye is immobilised in a polymer matrix, and the detection method uses a time gated measurement with excitation by a pulsed LED. The sensor film is stuck onto the inside of the package or jar with adhesive. The instrument consists of a small box containing the light source, detector and fibre reader pen and is connected to a PC. (OxySense). The problem with this sensor is that it only measures oxygen levels, when in fact it is normally a fall in O₂ levels and a concomitant rise in CO₂ levels which is indicative of microbial spoilage. Additionally, the sticker, which is in contact with the package contents, could become unstuck and possibly damage or otherwise interfere with the contents.

Many of the optical-based sensors for food packaging that have been made available are visual indicators in the form of inserts that also contain scavenging capability, and are not very accurate.

### OBJECT OF THE INVENTION

It is thus an object of the present invention to provide a CO₂ sensor which is substantially insensitive to O₂ levels under normal working conditions. It is also an object to provide a sensor which allows for the combined measurement of CO₂ and O₂ levels. It is also an object to provide an optically readable sensor for CO₂.

It is a further object to provide a sensor which is less sensitive to the moisture content of the environment, which can tolerate moderate fluctuations in the moisture content of the environment and which has a reliable calibration range over a range of moisture levels.

A further object of the invention is to provide a quality control method and a sensor for use in the method, for checking the integrity and hence microbial contamination of packaging, in a non-destructive manner. The invention also seeks to provide a packaging medium which incorporates a sensor which allows the integrity and level of microbial contamination of the package and its contents to be assessed. It is also an object of the invention to provide a quality control method which allows all of the manufacturer the possibility of checking each package i.e. 100% quality control and validation of modified atmosphere packaging process, and the retailer and the consumer the possibility of checking packages when they arrive at the retail outlet, on the shelves, at the purchase point so that the consumer can be secure in the knowledge that the food is fresh.

Another object of the invention is to provide a cheap and easy to produce gas sensor. In particular, it is an object to provide a printable or coatable sensor which can be easily applied to a surface such as a package, a label, a product surface or the like.

### SUMMARY OF THE INVENTION

According to the present invention there is provided a CO₂ sensor comprising a pH indicator and a long-lived reference luminophore, the reference luminophore either being doped in sol-gel particles and co-immobilised with the pH indicator in a porous sol-gel matrix, or being immobilised in a separate oxygen impermeable layer and the pH indicator in a sol-gel matrix being laid over the impermeable layer. Long-lived luminophore in this case means one that has a lifetime/decaytime long enough to be measured using low-cost instrumentation. In the case of this indicator, the unquenched decaytime is approx 5 μs.

The pH indicator may be hydroxypyrene trisulphonate (HPTS). Other suitable pH indicators include fluorescein, rhodamine B and other fluorescent pH indicators. HPTS is advantageous due to its spectral compatibility with the long-lived ruthenium reference indicator, its pKa value (˜7.3), its good photostability and high quantum yield.

The long-lived reference luminophore may be an oxygen-insensitive luminescent complex. A suitable luminophore is ruthenium-doped sol-gel particles. The particles may be either micro-or nano-particles. The ruthenium dopant in the sol-gel particles may be [Ru^{II}-tris(4,7-diphenyl-1,10-phenanthroline)]Cl₂ . Other suitable compounds are any luminescent complexes such as oxygen sensitive complexes or ruthenium-based compounds with α-diimine ligands or any luminescent transition metal complexes with platinum metals Ru, Os, Pt, Ir, Re or Rh as the central metal atom and α-diimine ligands, or phosphorescent porphyrins with Pt or Pd as the central metal atom or any luminescent doped crystals such as manganese-activated magnesium fluorogermanate, ruby, alexandrite and Nd-Yag.

The porous sol-gel matrix may be a methyltriethoxysilane (MTEOS) sol-gel matrix. Also suitable are other hybrid (organic-inorganic) sol-gel matrices such as ethyltriethoxysilane (ETEOS), phenyltriethoxysilane (PhTEOS), n-octyl TEOS and methyltrimethoxysilane (MTMS), UV-curable sol-gels, soluble ormosils, or hybrid polymer matrices.

In another aspect the invention provides a combined O₂/CO₂ sensor comprising:
(a) an O₂ sensor comprising an oxygen sensitive luminescent complex, immobilised in a porous sol-gel matrix, and
(b) an CO₂ sensor comprising a pH indicator and a long-lived reference luminophore, the reference luminophore either being doped in sol-gel particles and co-immobilised with the pH indicator in a porous sol-gel matrix, or being immobilised in a separate oxygen impermeable layer and the pH indicator in a sol-gel matrix being laid over the impermeable layer.

Suitable luminescent complexes include those ruthenium-based compounds with a-diimine ligands and luminescent transition metal complexes with platinum metals (Ru, Os, Pt, Ir, Re or Rh) as the central metal atom with a-diimine ligands, and phosphorescent porphyrins with Pt or Pd as the central metal atom or any luminescent doped crystals such as manganese-activated magnesium fluorogermanate, ruby, alexandrite and Nd-Yag.

The combined sensor may further comprise the immobilised O₂ sensor and the immobilised CO₂ sensor being coated onto the same substrate. Preferably, the two sensors are coated onto the substrate side-by-side. The substrate may be a layer of plastics material, including surface-enhanced PET, PE and PET/PE laminates or glass or any rigid substrate materials such as Perspex/PMMA, any polymer materials used to make DVDs for example polycarbonate, metal, or any flexible substrate material such as acetate (transparent foils for overhead projector), paper or flexible polymer materials. The sensor could also be coated onto or embedded in an optical fibre or capillary tube.

In a still further aspect the invention provides a method of making a CO₂ sensor comprising:
(1) synthesis of an Ru(dpp)₃(TSPS)₂ ion-pair comprising mixing dissolved Ru(dpp)₃Cl₂ with trimethylsilylpropane sulfonic acid, sodium salt and allowing the ion-pair to precipitate,
(2) synthesis of the particles comprising condensing the dissolved Ru(dpp)₃(TSPS)₂ ion-pair with TEOS and halting the condensation reaction with alcohol, washing the condensate with alcohol and drying the condensate,
(3) and fabrication of the CO₂ sensor films comprising (a.) suspending the doped reference particles in the coimmobilisation matrix solution, mixing the coimmobilisation matrix solution into a pH indicator solution which comprises a pH indicator in a quaternary ammonium hydroxide solution, and saturating the mixture immediately with CO₂ followed by deposition onto a substrate or (b.) employing a dual-layer configuration where a membrane consisting of the pH indicator, quaternary ammonium hydroxide and sol-gel is coated on top of an oxygen-insensitive epoxy layer containing a low oxygen sensitivity ruthenium complex (Ru(biby)₂(dpp)Cl₂ or Ru(bipy)₃Cl₂.

The quaternary ammonium hydroxide solution may be cetyl-trimetyl ammonium hydroxide (CTA-OH), tetra-octyl ammonium hydroxide (TOA-OH) or tetra-butyl ammonium hydroxide (TBA-OH) or other quaternary ammonium hydroxides. The invention provides for the adjustment of the dynamic range of CO₂ detection by selecting a specific quaternary ammonium hydroxide as well as adjusting the quantity of the hydroxide in the membrane formulation.

The invention also provides a packaging medium having a CO₂ sensor and an O₂ sensor as defined above formed on a surface of the medium which will lie internally of the package when the package is formed. The sensors may be formed on the packaging medium by dip-coating, spin-coating, spray-coating, stamp-printing, screen-printing, inkjet printing, pin-printing, lithiographic, flexographic or Gravure printing.

The invention also provides a quality control method comprising reading a combined O₂/CO₂ sensor as defined above, formed on the internal surface of a package, with an optical reader and determining the levels of O₂ and CO₂ inside the package in relation to a control. For example, a rise in O₂ level and a corresponding fall in CO₂ level indicating microbial contamination of the package.

The optical reader may comprise a probe with a transparent window, a fibre optic bundle with collimating optics both that interrogate the sensor non-invasively, or an invasive fibre tip encompassing the sensor on/in the fibre. There are two LEDs; the first is the excitation source and the second is the reference. The excitation source is a blue LED (Nichia, NSPB500) and is chosen for its relatively stable temperature characteristics which match those of the reference LED. The detector is a silicon photodiode (Hamamatsu, S1223), which also exhibits good temperature stability. Modulated light from the blue LED is filtered using a blue glass bandpass filter (OF1: Schott, BG12) of thickness 2 mm in order to eliminate the high wavelength tail of the LED emission. The phase-shifted fluorescence from the sensor film is incident on the photodiode after passing through an optical long-pass filter (OF3: LEE-gel filter 135), to separate the excitation light from the emission. The second LED (Hewlett Packard, HLMA-KL00) is part of an internal dual referencing scheme. This reference LED emits at 590 nm and is filtered by a bandpass filter (OF3: Schott, BG39). This LED is in the same spectral range as the fluorescence (610 nm), and has been carefully selected to match the blue excitation LED in terms of switching time and temperature characteristics. Spurious phase shifts as a function of temperature and other fluctuations are eliminated by this dual referencing. The detection electronics measure the variation in phase angle with oxygen or carbon dioxide concentration. The phase angle is the measured phase difference between the sinusoidally modulated reference excitation signal and the resultant fluorescence signal which is phase shifted with respect to the reference signal. The fluorescence signal changes with analyte concentration. The phase signals (reference and excitation) are fed into a phase detector and the phase difference is measured.

Also provided is a method of screen-printing a combined O₂/CO₂ sensor as defined above onto a substrate comprising forcing the sensor sol through a mask or mesh and drying the substrate. Preferably the substrate is dried at about 80° C. for about 10 min.

Also provided is a method of ink-jet printing a combined O₂/CO2 sensor as defined above onto a substrate comprising filling an ink-jet printer cartridge/reservoir with sensor sol and printing the sensor sol onto the substrate using an ink-jet printer. A number of different commercial ink-jet printers have been used (e.g. Microfab ink-jet printer Domino Macrojet printer).

Also provided is a method for pin printing onto substrate using pins to deposit spots or patterns of sol-gel onto a substrate.

In another aspect the invention provides a method of forming a gas-sensitive sensor on a substrate comprising coating or printing the substrate with a porous sol-gel matrix comprising a gas sensitive indicator. Also provided is a substrate having a gas-sensitive sensor formed thereon wherein the sensor comprises a sol-gel matrix comprising a gas sensitive indicator and the sensor has been formed by printing or coating. The sensor may be adapted to detect a variety of gasses. The gas sensors may be luminophore-based or colorimetric-based sensors. Colorimetric sensors may be based on indicators such as m-cresol purple, thymol blue, phenol red, xylenol blue, and the like, Luminophore-based sensors may be the CO₂ or O₂ sensors described above, or the like.

### BRIEF DESCRIPTION OF THE DRAWINGS

FIG. 1: is a digital image of Ru-doped MTEOS films screen-printed onto PET under blue LED excitation with a red filter,

FIG. 2: Single sine wave signals generated by the reference luminophore (Reference) and the analyte-sensitive luminophore (HPTS). The superposition of the two signals represents the detected signal (Total Signal),

FIG. 3: Schematic of experimental system used to measure the oxygen and carbon dioxide sensitivity of the sensor films,

FIG. 4: Calibration data for CO₂ sensor using N₂ as carrier gas for the first cycle, and air as carrier gas for the second cycle,

FIG. 5: Oxygen calibration data from screen printed films, and

FIG. 6: Ink-jet printed oxygen sensor films on acetate substrate.

FIG. 7: Calibration data for R-4 PhTEOS showing better resolution at higher concentrations of oxygen.

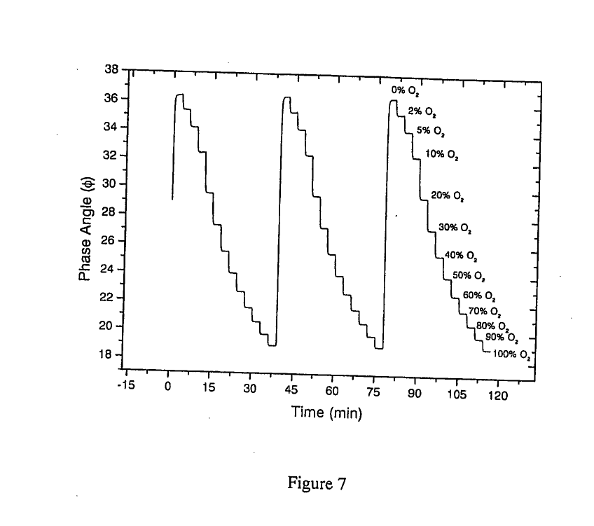

FIG. 8: Calibration plots for DLR-based carbon dioxide sensor films using the five tested quaternary ammonium bases and the HPTS pH-indicator.

FIG. 9: Performance of the CO₂ sensor films as an insert in a food package filled with various concentrations of CO₂ gas (Reference probe—Gascard II IR gas monitor).

FIG. 10: Array of pin printed sol-gel sensor spots on a silicon substrate—sensor spot diameter approx. 100 μm.

### DETAILED DESCRIPTION OF THE INVENTION

Optical sensor films with associated scanner to confirm the integrity of the package and hence freshness of packaged food in a non-destructive manner. Sensor films have been developed for oxygen and carbon dioxide. They are fluorescent and their fluorescence changes with exposure to the specific gas concentration. The films can be deposited on a solid or a flexible substrate using standard printing techniques e.g. spin coating, screen printing etc. The films are excited by a common excitation source i.e. a blue LED, and the resultant fluorescence is detected using a silicon photodiode. These optoelectronic components along with relevant ICs and electronic components can be housed in an optical reader or scanner device capable of interrogating the sensor films.

Fluorescent sensors for oxygen and carbon dioxide have been developed. Both of these sensors can be scanned using an optical reader, which will give a readout of the concentration of oxygen and carbon dioxide in the package using non-destructive methods. This will enable 100% quality control from the packaging plant to the consumer purchase point.

Oxygen sensor formulation: It is based on an oxygen-sensitive dye complex, [Ru-tris(4,7-diphenyl-1,10-phenanthroline)]Cl₂, immobilised in a porous hybrid sol-gel matrix. The oxygen gas can diffuse through the matrix and quench (reduce) the intensity and decay-time of the fluorescence from the dye complex. The preferred method of detection monitors the decay-time of the indicator, hence detection is in the time domain and uses low-cost instrumentation. As the oxygen concentration increases, the intensity/decay-time decreases. The formulation can be deposited/printed onto a support matrix—in the case of the intelligent packaging application, the sensor film is deposited onto a flexible packaging material.

Carbon dioxide formulation: This sensor is more complex than the oxygen sensor, and uses a technique known as Dual Luminophore Referencing (DLR) [Ger. Pat. Appl., DE 198.29.657, 1997]. This technique enables CO₂ sensing of a short-lived indicator in the time domain using lost-cost instrumentation. Carbon dioxide sensing exploits the acidic nature of the gas. Most reported fluorescence-based optical carbon dioxide sensors rely on the intensity change of a luminescent pH indicator such as 1-hydroxypyrene-3,6,8-trisulfonate (HPTS), but the very short decay times of such species cannot be measured by the low-cost phase modulation techniques used for oxygen sensors. The present invention offers the possibility of an optical sensing scheme for CO₂, which is compatible with that for oxygen. In the CO₂ sensor, [Ru(dpp)₃]Cl₂, used above for the oxygen sensor, is used as the reference luminophore as well as other luminescent complexes with low-oxygen or zero oxygen sensitivity, in the DLR-based CO₂ sensor strip. Excitation and emission wavelengths of ruthenium complexes and the HPTS dye are sufficiently well matched to make them excellent candidates for a DLR-type carbon dioxide sensor and the use of the same ruthenium complex in the oxygen sensor strip, ensures excellent cross compatibility between the two sensors, enabling the use of a single optical read-out device in the food packaging application. Due to the extremely good quenchability by molecular oxygen of the ruthenium complex used as the reference in the CO₂ sensor strip, the dye is incorporated in sol-gel particles, to minimize oxygen cross-sensitivity. These particles are fabricated using the sol-gel process with TEOS as precursor. These particles are sensitive to oxygen, but when they are immobilized in the MTEOS sol, that they are no longer oxygen-sensitive.

1. Fabrication Process

1.1 Synthesis of O₂ Sensor

One example of an O₂ sensor is composed of an oxygen-sensitive complex, Ru-tris(4,7-diphenyl-1,10-phenanthroline)²⁺ immobilised in a porous sol-gel matrix. The silicon alkoxide precursor, methyltriethoxysilane (MTEOS) is mixed with water at pH 1 (using HCl as catalyst) and ethanol as co-solvent. The MTEOS to water ratio used is 1:4. The ruthenium complex is added to the precursor solution and the mixture stirred for 1 h. The typical concentration of the ruthenium complex used is 2.5 g/L with respect to the precursor solution. After stirring for one hour, the sol is used to coat the substrates or supports onto which the sensor material is deposited e.g. Glass, PMMA, Flexible packaging material, acetate, adhesive labels, DVDs, metal, paper etc

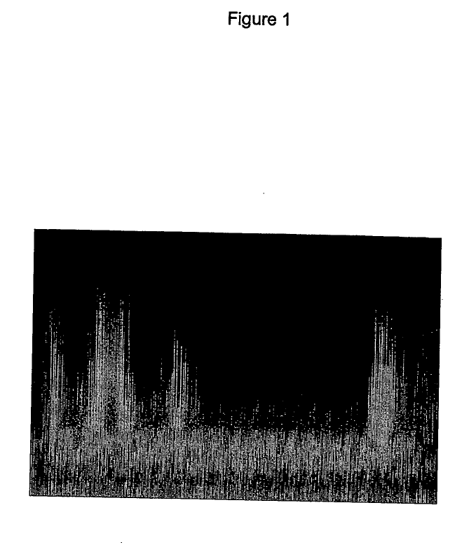

1.2 Another suitable oxygen sensor formulation utilises R=4 PhTEOS which gives a greater sensitivity/resolution at higher oxygen concentrations. FIG. 1 shows the calibration data for R-4 PhTEOS and the resolution at higher concentrations of oxygen.

To 1.0376 ml of H₂O pH1, add 5.2542 ml of C₂H₅OH (pure ethanol) and stir. Add this ethanol water mixture to 0.02503 g of the oxygen-sensitive ruthenium dye complex and stir well. Then add 3.4739 ml PhTEOS drop wise while stirring. Stir for 24 h and deposit on substrate of choice using a lab deposition or printing technique.

1.3 A Formulation Based on N-Octyl TEOS (C8TEOS)

Solution A
60% C8TEOS:
1.078 g C8TEOS
0.56 mL TEOS
1.25 mL pure EtOH
0.4 mL 0.1 N HCl
Mix components of Solution A magnetically for 1 hour at room temperature.
Add the following to a glass vial:
270 uL solution A
270 uL pure EtOH
60 uL of 2 mM Ru dissolved in EtOH=>6 mg Ru in 2.566 mL (2566 uL) EtOH
Cap vial and stir mixture magnetically for 10 mins. at room temp. Then spin coat slides with sol at 3000 rpm for 30 s. Ramp for 6 s.
Slides are stored in a labelled petri dish for 1 week in the dark at room temp to allow films to dry.
   1.4 A Uv-Curable Sol-Gel

This outlines the formulation for an O₂-sensitive uv-patternable sol-gel. The sol-gel precursors are 3-(trimethoxysilyl)-propylmethacrylate (MPTMS), tetraethoxysilane (TEOS) and zirconium propoxide. Methacrylic acid was added to complex the zirconium precursor. The photoinitiator used for the radical polymerisation was Irgacure 1800. The concentration of oxygen-sensitive Ruthenium dye complex used is 2.7×10⁻⁴ mol.cm³.

Solution A: MPTMS (20 mL), TEOS (10.1075 mL), HCl (5.7685 mL) were stirred at 80° C. In a separate vial Solution B, zirconium propoxide (6.6393 mL) and methacrylic acid (4.6122 mL) were mixed for 15 minutes. Solution A and B were then mixed for 1 h, after which water was added and the solution was stirred for 120 mins. Finally the photoinitiator, Irgacure (0,7642 mL) was added. Typically the end solution is coated onto a silicon wafer, or glass/plastic substrate by spin coating and dried at 70° C. for 1 h. The structures are then produced by uv-exposure through a mask for 40 mins using a uv lamp which provided an intensity of 100 mW cm⁻² in the 320-400 nm region. The non-illuminated areas are washed away with propan-2-ol leaving the desired structures e.g. waveguides or spot arrays.

1.2 Synthesis of CO₂ Sensor

CO₂ sensor is composed of a pH indicator, hydroxypyrene trisulphonate, HPTS, (exploiting the acidic nature of the CO₂ gas i.e. CO₂ is converted to carbonic acid in the presence of water) and a long-lived reference luminophore, ruthenium-doped sol-gel microparticles, co-immobilised in a porous (MTEOS) sol-gel matrix. The production of the CO₂ sensor films is structured in three phases: synthesis of the Ru(dpp)₃(TSPS)₂ ion-pair, synthesis of the particles and fabrication of the CO₂ membranes.

(a.) Synthesis of Ru(dpp)₃(TSPS)₂:

Dissolve 400 mg Ru(dpp)₃Cl₂ in 70 ml of a 10/4-mixture acetone/ethanol.
Add 50 ml of H₂O and filter.
Add a filtered solution of 218.3 mg trimethylsilylpropane sulfonic acid, sodium salt (Na-TSPS) in 50 ml deionised H₂O and filter the mixture again.
Let stand until the mixture is evaporated down to 70-100 ml and the ion-pair has precipitated. This normally takes a couple of days, or overnight in the fume hood.
Filter and wash with plenty of water.
Weigh after drying at 70° C.
   (b.) Synthesis of the TEOS μ-particles:
Dissolve 380 mg of the Ru(dpp)₃,(TSPS)₂ ion-pair in 23.05 ml of acetic acid (HOAc) and add 7.25 ml of deionised H₂O.
Add 22.45 ml of TEOS and stir for 90 seconds. Switch stirrer off and let the solution stand for a further 13.5 minutes, during which it will start to turn opaque (formation of a suspension).
Add 50 ml of ethanol (EtOH) to stop the condensation reaction and let the suspension stand for 30 minutes.
Filter (keep the filtrate and do not add acetone to it) and wash with acetone, until the washing liquid is colourless.
Dry at 70° C. for three days, grind the crusted particles in the mortar and weigh: 1.539 g of a lightly orange coloured very fine powder

Note that the above formulation produces particles the diameter of which can be tailored from approx. 50 μm down to nanoparticles of diameter approx. 15 nm by adjusting the stirring time of the solution.

(c.) Membrane Preparation:

(i) Membrane Containing Reference Particles

Prepare CTA-OH solution: stir 1.432 g CTA-Br and 0.911 g AgO over 6 ml MeOH for 2 h, then filter with a PTFE filter.
Suspend 160 mg of the doped particles in 4.0 ml MTEOS, add 1.45 ml of 0.1 M HCl and stir for 2 h.
In a second vial, dissolve 30 mg HPTS in 5 ml of the freshly prepared CTA-OH solution
Pour the MTEOS mixture into the HPTS solution and saturate the mixture immediately with CO₂, by bubbling a stream of 100 % CO₂ through it for about two minutes.
Spin-coat the cocktail onto a PE substrate using 1000 RPM spin speed. The substrate should be already spinning when the cocktail (˜2 ml) is applied to it. Make sure that the cocktail is well mixed before spin-coating, so the particles do not sediment on the bottom of the vial.
Dry the substrates at 70° C. for four days, then store in a moist atmosphere.
   (ii) Non-Particle Dual-Layer Membrane

An alternative formulation consists of a dual-layer configuration. An initial layer consisting of a low oxygen-sensitivity ruthenium complex (e.g. Ru(biby)₂(dpp)Cl₂ or Ru(bipy)₃Cl₂) immobilised in an oxygen impermeable epoxy (e.g. EPO-TEK 301, Promatech, UK.) is deposited. The layer is cured at room temperature. The overlayer consists of the HPTS-based sensing membrane as detailed in (i). with particles omitted.

2. Tailoring the Detectable Concentration Range of the CO₂ Sensor

The sensitivity of a carbon dioxide sensor is linked to the equilibrium constant of the pH indicator used (pK_{A}) and to the nature of the buffer that surrounds it. In the case of our CO₂ sensors (solid-type), they do not contain a classic aqueous buffer system, but they contain a quaternary ammonium hydroxide in a hydrophobic membrane. It is possible that the size and shape of the ammonium cation can affect the HPTS pH-indicator sensitivity by influencing how strongly the positive charge is shielded from the protonable group. TOA-OH is a typical base used in these type of sensors but the sensitivity of the sensor can be reduced by using a smaller, less-spherical quaternary ammonium base e.g. CTA-OH.

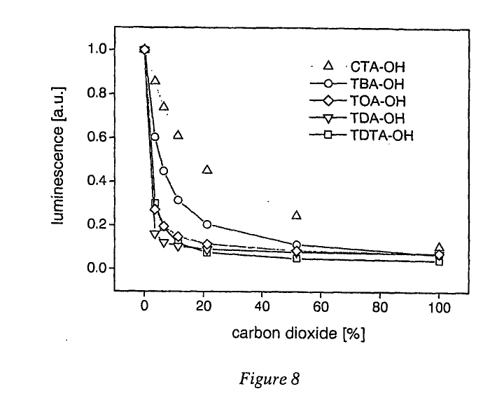

FIG. 8 shows the effect of different quaternary ammonium bases on the sensitivity of the carbon dioxide sensor, hence the ability to tailor the sensor sensitivity by varying the base used.

3. Printing Process

The standard lab deposition/printing techniques are: dip-coating, spin-coating, spray coating and stamp printing. However for the food packaging or other commercial applications, an industrial-scale printing technique is necessary. For this reason the possibility of printing doped sol-gels was investigated, using screen-printing, pin-printing and ink-jet printing using a standard desktop or commercial printer and ink-reservoir or cartridge.

3.1 Screen printing involves forcing the ‘ink’ (oxygen sensor sol) through a mask/mesh containing the design using a ‘squeegee’ (a spongy wiper) and printing the desired design on the substrate positioned below the mask. Once printed the substrate was then dried as it was moved through a horizontal four-chamber oven at 80 degrees C. for 10 minutes. The mask used for the screen-printing trials consists of a series of lines of different widths and separations as can be seen in FIG. 1. Two different substrates were used (both flexible). The first was the standard surface-enhanced PET (50 μm HSPL), and the second was a specialised packaging material (Dyno AF320, Polimoon, U.K.) that is compatible with a conventional Modified Atmosphere Packaging (MAP) instrument. This packaging material is a laminate consisting of PET/PE with an antifog layer.

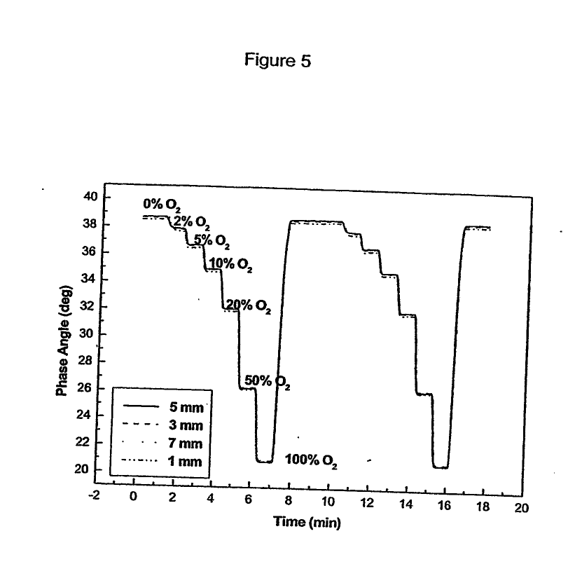

Overall the screen printing trials were successful using the oxygen sensor sol. Some of the issues encountered with this process were associated with the viscosity of the sol. Normally, high viscosity inks (of the order of thousands of cP) are used for screen printing. Our sensor ink has a very low viscosity (approx 2 cP), which results in fast evaporation of the solvent and consequent drying leading to high losses of materials and clogging of the mask. Adhesion of the printed film to the anti-fog layer on the packaging material was found to be a problem, but was very good when the films were printed on the surface-enhanced PET material. Data on the oxygen sensitivity of the screen printed films can be seen in FIG. 5.

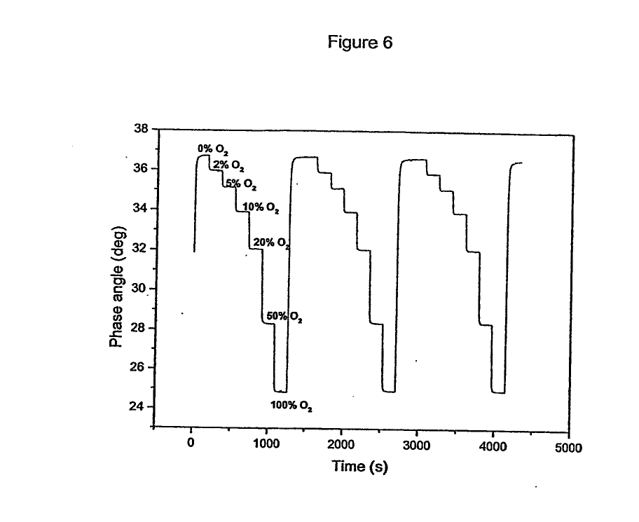

3.2 Ink-jetprinting trials were carried out using a standard HP ink-jet printer (HP DESKJET 920C), a Microfab printer and a Domino Macrojet printer. A cartridge was filled with oxygen sensor sol. The viscosity of the sol is well suited to this technique, as the optimum viscosity of inks for use in ink-jet printing is between 2 and 5 cP. A series of lines of sensor were printed onto both paper and acetate. The quality of the films and adhesion to the acetate was very good. The oxygen sensitivity of the ink-jet printed films can be seen in FIG. 6. Text and logos were printed using the oxygen-sensitive sol which clearly demonstrates the versatility of this technique. In the case of the Microfab (piezoelectric) printer, a reservoir was filled and the substrate was positioned on a xyz stage and spots, squares and lines were printed. Using the Macrojet printer, a reservoir was filled with ink and spots/arrays of spots were printed by firing the sol-gel ink through the apertures onto the substrate.

3.3. Pin Printing

The pin printer is a Cartesian Technologies MicroSys 4100 or now called Genomic Solutions OmniGrid Micro. It can use either 96 well or 384 well plates—depending on dispensing volumes. The z axis can be controlled as well as the x, y axis and can print on elevated structures. All parts of the print cycle such as wash, fill, spot etc. can be controlled and optimised for different substrates and samples. The pin printer can use standard solid pins or split pins and with between 1 pin and 24 pins. Different size pins can be purchased for different ranges of spot diameters. In our case, the pin printer uses Stealth Technology from TeleChem (Using SMP3 pins). This pin has a narrow uptake channel along the length of the pin which picks up the sample to be spotted. The pin has a flat surface on the bottom and a layer of sample is formed here, approximately 25 μm thickness, and stamped onto the substrate.

With this pin we have printed sol-gel sensing films onto PMMA chips of various dimensions and with elevated structures, silicon substrates with photo patterned waveguides, and on glass slides. We have also printed Cy5 dye onto glass slides.

| Substrate | Spot Material | Spot Diameter |
|---|---|---|
| Glass | Sol-gel/Cy5 | 50 μm-150 μm |
| PMMA | Sol-gel | 50 μm-150 μm |
| Silicon | Sol-gel | 50 μm-150 μm |

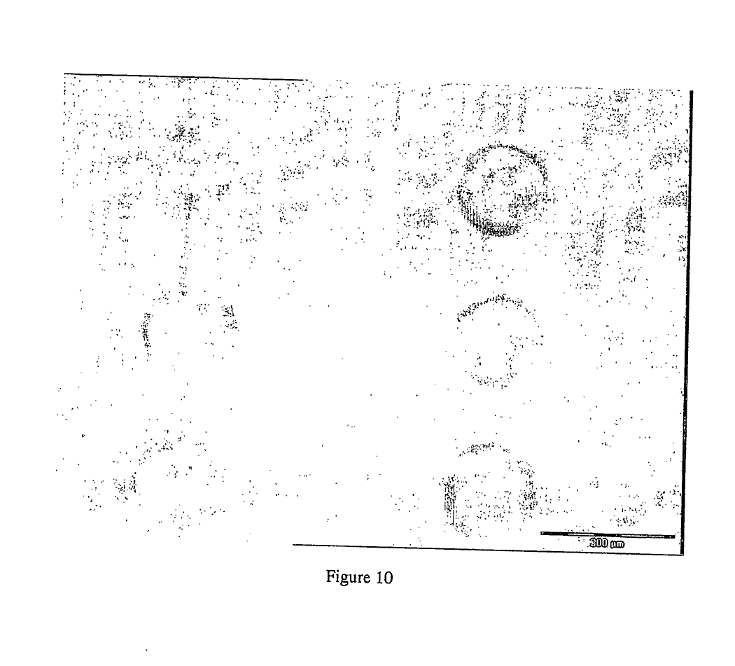

The spot diameter for all the substrates and sensors printed so far are between 5 μm and 150 μm depending on the printing parameters selected. The thickness is in the range 1 μm to 5 μm. FIG. 10 shows a typical array of pin printed sol-gel sensor spots on a silicon substrate—diameter approx. 100 μm.

4. Measurement/Testing Process

4.1 A phase fluorometric approach is used in the measurement of the oxygen sensor, which involves operating in the time domain. If the excitation signal is sinusoidally modulated, the dye fluorescence is also modulated but is time delayed or phase shifted relative to the excitation signal. The relationship between the lifetime, τ, and the corresponding phase shift, φ, for a single exponential decay, is

$$τ = \frac{tan ϕ}{2 π f} \qquad ( 1 )$$

where f is the modulation frequency.

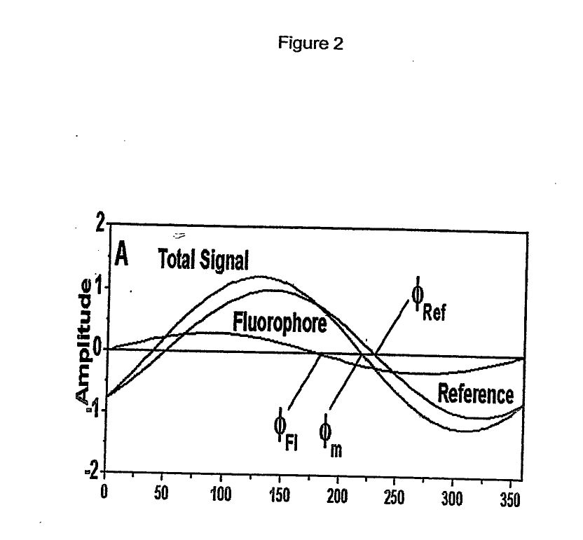

4.2 Dual Luminophore Referencing is a sensing technique used by us to measure carbon dioxide. It enables the conversion of the analyte-sensitive fluorescence intensity signal to the time domain by co-immobilising the analyte-sensitive indicator (pH indicator, HPTS) with an inert long-lifetime reference luminophore (ruthenium-doped sol-gel microparticles) with similar spectral characteristics. Two different luminescence signals are generated in the sensing membrane (see FIG. 2). The total signal amplitude (in red) is a superposition of the two signals generated by the analyte-sensitive fluorophore (HPTS-black) and the inert reference luminophore (Reference-Blue). The HPTS signal has a phase angle, φ_{sig}≈0 due to its very short lifetime, and the inert reference signal has a constant amplitude and phase angle, φ_{ref}, determined by the modulation frequency and its decay time. The superposition of the two signals will result in a non-zero phase angle, φₘ, of the total measured signal. When the HPTS changes its amplitude due to the presence or absence of carbon dioxide, the phase angle φₘ will change accordingly, thus φₘ can be correlated with the HPTS fluorescence intensity. A theoretical analysis of the process shows that cot φₘ is linearly dependent on the amplitude ratio of the two signals A_{HPTS}/A_{REF}, thereby referencing out any drifts that might occur due to power fluctuations or temperature changes.

4.3 Characterisation System

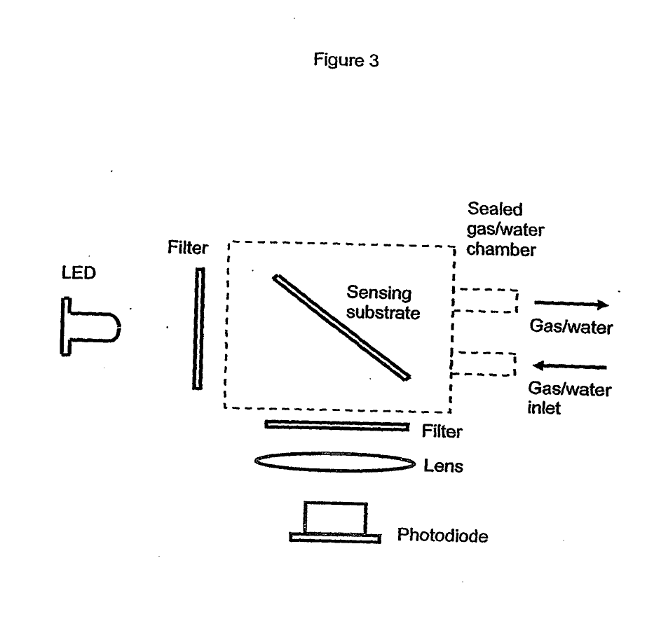

FIG. 3 shows the laboratory/modular characterisation system used to measure the sensitivity of the sensor films.

A digital dual-phase lock-in amplifier (DSP 7225 Perkin Elmer Instruments, USA) was used for sinusoidal modulation of the LED (20 kHz/5.0 V) and for phase-shift detection of the photodiode output signal. The optical set-up consisted of a blue LED (λₘₐₓ=470 nm, NSPB 500 Nichia, Germany) with a blue band-pass filter (BG-12, Schott, Mainz, Germany) and an integrated photodiode amplifier (IPL 10530 DAL, IPL Inc, Dorset, UK) with an orange long-pass filter (LEE 135, LEE Filters, Hampshire, UK).

For testing the carbon dioxide sensor, the desired concentrations of carbon dioxide were adjusted by mixing pure gases (carbon dioxide and nitrogen) with computer-controlled mass flow controllers (UNIT Instruments, Dublin, Ireland). The gas mixture was humidified using two midget impingers (to duplicate the humid atmosphere in a modified atmosphere package) and the flow rate was kept constant at 500 cm³ min⁻¹. A similar set-up was used to achieve calibrated oxygen concentrations.

5. Sensing Mechanisms

5.1 Oxygen Sensing Mechanism:

The oxygen sensing mechanism involves fluorescence quenching. This refers to any process which decreases the fluorescence intensity (or lifetime) of a given substance. In this work, we are concerned primarily with quenching resulting from collisional encounters between the fluorophore and the quencher (in this case oxygen) called collisional quenching. In this case, the quencher must diffuse to the fluorophore during the lifetime of the excited state. Upon contact, the fluorophore returns to the ground state without emission of a photon. The observed decay is composed of both radiative and non-radiative decay. As the concentration of quencher increases, the non-radiative decay increases, and thus the observed lifetime will decrease with accompanying decrease in fluorescence intensity. Collisional quenching of fluorescence is described by the Stern-Volmer equation:

$$\begin{matrix}\frac{{I}_{0}}{I} = 1 + k {τ}_{0} [ Q ] = 1 + {K}_{SV} [ Q ] & ( 2 ) \\ \frac{{τ}_{0}}{τ} = 1 + k {τ}_{0} [ Q ] = 1 + {K}_{SV} [ Q ] & ( 3 )\end{matrix}$$

where I₀ and I are the fluorescence intensities in the absence and presence of quencher, respectively, [Q] is the concentration of quencher, τ₀ and τ are the fluorescence lifetimes in the absence and presence of quencher, respectively, and K_{SV} is the Stern-Volmer quenching constant. In this work, the ruthenium dye complex is the fluorophore and oxygen is the quencher.
5.2 Carbon Dioxide Sensing Mechanism:

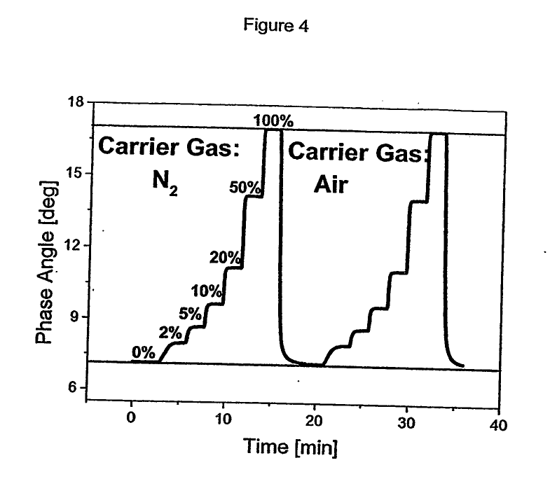

Optical CO₂ sensing is normally achieved indirectly by exploiting the acidic nature of the gas. As a result, pH-indicator dyes can be used. In this work, a fluorescence approach is used in order to be compatible with the oxygen sensing scheme. The equation shown below (Eqn. 4) shows the sensing chemistry involved in the carbon dioxide sensor:
Q⁺D⁻+CO₂+H₂O→H⁺D⁻Q⁺HCO₃⁻ (4.)
where D⁻ is a pH-indicator dye and Q⁺ is the counter ion. This mechanism takes advantage of the acidic nature of the carbon dioxide gas (converted to carbonic acid in the presence of water), and monitors the concentration of CO₂ gas via the pH change it induces. Using the aforementioned DLR scheme, HPTS (pH indicator) and Ru-doped microparticles (reference) co-immobilised in a sol-gel matrix, the fluorescence intensity signal generated by the HPTS is converted to the time domain giving a phase signal compatible with that of the oxygen sensor. This formulation works well as can be seen from the CO₂ sensor data in FIG. 4. These data indicate the excellent CO₂ sensor response without any cross-sensitivity to 02. There is no discernable difference between the two cycles even though the second cycle contains air which has a 20% oxygen content.
5.3 Particles

Testing of the inert Ru-doped reference particles has shown that they are sensitive to oxygen gas when outside the MTEOS matrix. The stage at which they are incorporated into the MTEOS matrix and co-immobilised with the HPTS has an effect on the response of the CO₂ sensor to oxygen. It has been found that introducing the particles into the MTEOS sol prior to hydrolysis and condensation results in a more uniform film and better sensor reproducibility within the batch.

The alternative dual-layer approach ensures that the long lifetime reference complex (e.g. ruthenium complex) is sealed in an oxygen-impermeable sub layer with CO₂-sensing layer on top. Choice of formulation is dependent on the required application.

6. Data

6.1 Screen Printing:

FIG. 5 shows the calibration data from oxygen sensor films screen printed onto HSPL substrate. Lines of different widths and separations were printed and the response of these films can be seen in FIG. 5. The films adhere well to the substrate and the quality of the films is good. The sensitivity of the films is high at low oxygen concentrations, which suits the food packaging application. FIG. 1 above shows a digital image of the screen-printed films under blue LED excitation with a red filter over the camera lens.

6.2 Ink-Jet printing:

As mentioned previously, a standard ink-jet printer was used to print oxygen sensor films onto both paper and acetate. Calibration data from the ink-jet printed films is shown in FIG. 6. The quality of the films is good and the process is very versatile.

7.1 Testing the Operation of the O₂ Sensor Under Simulated Conditions

An oxygen sensor film was placed in a sealed container (simulated package). This ‘intelligent package’ was interrogated using an optical fibre-based reader instrument connected to a laptop computer. A graph of the oxygen concentration was plotted in real-time and the oxygen concentration displayed on the screen. The sealed container was evacuated using a small vacuum pump to reduce the oxygen content as close as possible to zero. The pump was then turned off and air was allowed to leak back into the ‘package’. This procedure was carried out a number of times. Typically the concentration varied between 2% (evacuated) and 20.5% oxygen (air-saturated). The lower value did not drop below 2% due to the inability of the vacuum pump to completely evacuate the sealed container and not due to the operation of the oxygen sensor film.

7.2. Testing the Operation of the CO₂ Sensor Under Simulated Conditions

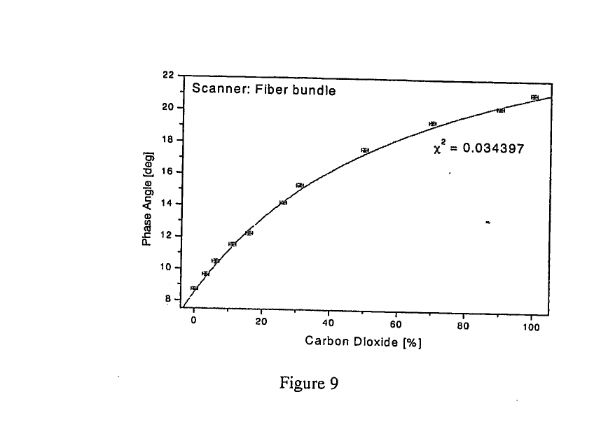

A CO₂ sensor film was placed inside a sealed package (simulated package) that was filled with various concentrations of carbon dioxide gas. A fibre bundle was used to optically interrogate the ‘intelligent package’, and a reference probe (Gascard II IR gas monitor) was used for comparison purposes. These data shown in FIG. 9 show excellent correlation.

In summary, optical sensors for oxygen and carbon dioxide have been developed. The indicators are immobilised in a sol-gel matrix which has many advantages i.e. ease of printability, ability to tailor the matrix to suit the particular application in particular to optimise the sensitivity of the sensor to the sensing region of interest.

The carbon dioxide indicator is a pH indicator, HPTS. Due to its short lifetime, a novel technique called DLR has been employed to enable decay-time detection in the frequency domain. The HPTS is co-immobilised in a sol-gel (MTEOS) matrix with Ru-doped sol-gel particles. The DLR mechanism is described above and the following equation describes the mechanism

$$cot {ϕ}_{m} = cot {ϕ}_{Ref} + \frac{1}{sin {ϕ}_{Ref}} \cdot \frac{{A}_{HPTS}}{{A}_{Ref}}$$

In short the cotangent of the measured phase angle φₘ is linearly dependent on the amplitude ratio of the two signals, HPTS and Ru reference.

The particles are oxygen-insensitive when immobilised in the MTEOS sol-gel, and act as a reference luminophore for DLR. As for the oxygen sensor, the phase angle is measured as a function of oxygen concentration.

The detection electronics measure the variation in phase angle with oxygen or carbon dioxide concentration. The phase angle is the measured phase difference between the sinusoidally modulated reference excitation signal and the resultant fluorescence signal which is phase shifted with respect to the reference signal. The fluorescence signal changes with analyte concentration. The light sources are two light-emitting diodes, one yellow (reference which does not excite the indicators) and one blue (excitation source which excites the analyte-sensitive indicator). These light sources are modulated at 20 kHz. The detector is a silicon photodiode, and the phase signals (reference and excitation) are fed into a phase detector and the phase difference is measured.

The sensor of the present invention is a fluorescence-based sensor that needs an analyser to ‘read’ the gas concentration [Retailers prefer that the consumer cannot determine the quality of the food, hence this is more advantageous than a visual indicator]. It is a non-invasive analyser system that can measure both oxygen and carbon dioxide, so a true indication of what is happening in the package is possible. For example, many articles and foodstuffs are packaged under modified gas atmospheres. If such a package is punctured one would expect to see a change in oxygen and carbon dioxide levels to equate with atmospheric levels and this could be determined with the sensor system of the present invention. If a package then becomes contaminated by microbes, the oxygen can be consumed by microbial growth, so it is important to have a measure of both oxygen and carbon dioxide concentration to determine the quality of the package, hence the freshness of the food as carbon dioxide accumulation in a package headspace can be considered to be a sign of microbial growth. Overall, the invention allows the possibility of monitoring gas levels in the package over time and comparing them with standards which allows an assessment of the integrity of the package to be made.

The indicator chemistry used for the two sensors enables the use of a common light source (blue LED) and detection system, hence the analyser instrument is capable of reading both sensors.

The fact that it is a non-destructive sensor enables 100% monitoring of the packages at any stage from the packaging plant to the consumer purchase point. It could also easily be integrated into a production line.

Printing the sensors directly onto the packaging material is a distinct advantage from a consumer point of view. A European FAIR-project ‘Actipak’ CT 98-4170 entitled ‘Evaluating safety, effectiveness, economic-environmental impact and consumer acceptance of active and intelligent packaging’ found that in Europe, consumers were negative about separate pouches or objects included in packaging. Their main concerns were that sachets would break or that accidental injection would occur. By printing the sensors onto the packaging material, they can be largely ‘invisible’ to consumers if necessary. Sensors are printed onto the packaging material and not onto an adhesive or sticker and so are more secure. It is also, however, possible using the sensors and methods of the invention to apply the sensor directly onto certain products such as a DVD surface.

The words “comprises/comprising” and the words “having/including” when used herein with reference to the present invention are used to specify the presence of stated features, integers, steps or components but does not preclude the presence or addition of one or more other features, integers, steps, components or groups thereof.

1. A CO₂ sensor comprising a pH indicator and a long-lived reference luminophore, the reference luminophore either being doped in sol-gel particles and co-immobilised with the pH indicator in a porous sol-gel matrix, or being immobilised in a separate oxygen impermeable layer and the pH indicator in a sol-gel matrix being laid over the impermeable layer.

2. A CO₂ sensor as claimed in claim 1 wherein the pH indicator is selected from the group consisting of pH indicators including hydroxypyrene trisulphonate (HPTS), fluorescein, rhodamine B and other fluorescent pH indicators.

3. A CO₂ sensor as claimed in claim 1 wherein the long-lived reference luminophore is selected from the group consisting of a luminescent complex, in particular [Ru^{II}-tris(4,7-diphenyl-1,10-phenanthroline)]Cl₂, ruthenium-based compounds with α-diimine ligands, luminescent transition metal complexes with platinum metals Ru, Os, Pt, Ir, Re or Rh as the central metal atom and with α-diimine ligands, and phosphorescent porphyrins with Pt or Pd as the central metal atom or luminescent doped crystals such as manganese-activated magnesium fluorogermanate, ruby, alexandrite and Nd-Yag.

4. A CO₂ sensor as claimed in claim 1 wherein the porous sol-gel matrix is selected from the group consisting of a methyltriethoxysilane (MTEOS) sol-gel matrix, hybrid (organic-inorganic) sol-gel matrices including ethyltriethoxysilane (ETEOS), phenyltriethoxysilane (PhTEOS), n-octyl TEOS and methyltrimethoxysilane (MTMS), and UV-curable sol-gels, soluble ormosils, or hybrid polymer matrices.

5. A CO₂ sensor as claimed in claim 1 wherein the luminophore is a ruthenium-doped sol-gel particle, in particular [Ru^{II}-tris(4,7-diphenyl-1,10-phenanthroline)]Cl₂-doped particles.

6. A CO₂ sensor as claimed in claim 1 wherein the pH indicator and the long-lived reference luminophore are co-immobilised in a sol-gel matrix.

7. A combined O₂/CO₂ sensor comprising:
(a) an O₂ sensor comprising an oxygen sensitive luminescent complex immobilised in a porous sol-gel matrix, and
(b) an CO₂ sensor comprising a pH indicator and a long-lived reference luminophore, the reference luminophore either being doped in sol-gel particles and co-immobilised with the pH indicator in a porous sol-gel matrix, or being immobilised in a separate oxygen impermeable layer and the pH indicator in a sol-gel matrix being laid over the impermeable layer, the sensor being interrogatable by an optical reader wherein the phase difference of a reference and an excitation phase signal is measured.

8. A combined O₂/CO₂ sensor wherein the pH indicator and the long-lived reference luminophore are co-immobilised in a porous sol-gel matrix.

9. A combined O₂/CO₂ sensor as claimed in claim 8 wherein the ruthenium-complex is selected from the group consisting of an oxygen sensitive luminescent complex such as ruthenium-based compounds with α-diimine ligands and luminescent transition metal complexes with platinum metals (Ru, Os, Pt, Ir, Re or Rh) as the central metal atom and with α-diimine ligands, and phosphorescent porphyrins with Pt or Pd as the central metal atom or luminescent doped crystals such as manganese-activated magnesium fluorogermanate, ruby, alexandrite and Nd-Yag.

10. A combined O₂/CO₂ sensor as claimed in claim 8 wherein the immobilised O₂ sensor and the immobilised CO₂ sensor are coated onto the same substrate.

11. A combined O₂/CO₂ sensor as claimed in claim 8 wherein the two sensors are coated onto the substrate side-by-side.

12. A combined O₂/CO₂ sensor as claimed in claim 5 wherein the substrate is selected from the group consisting of plastics materials including surface-enhanced PET, PE and PET/PE laminates, adhesive plastic labels, rigid substrate materials including glass, Perspex/PMMA, polymer materials from which DVDs are made for example polycarbonate and other polymer materials, metal, and flexible substrate materials including acetate or flexible polymer materials, paper, optical fibre or glass/plastic capillary tubes.

13. A method of making a CO₂ sensor comprising:
(1) synthesis of an Ru(dpp)₃(TSPS)₂ ion-pair comprising mixing dissolved Ru(dpp)₃Cl₂ with trimethylsilylpropane sulfonic acid, sodium salt and allowing the ion-pair to precipitate;
(2) synthesis of the particles comprising condensing the dissolved Ru(dpp)₃(TSPS)₂ ion-pair with TEOS and halting the condensation reaction with alcohol, washing the condensate with alcohol and drying the condensate; and
(3) fabrication of the CO₂ sensor films comprising suspending the doped reference particles in the coimmobilisation matrix solution, mixing the coimmobilisation matrix solution into a pH indicator solution which comprises a pH indicator in a quaternary ammonium hydroxide solution, and saturating the mixture immediately with CO₂ followed by deposition onto a substrate.

14. A method of making a CO₂ sensor in a dual-layer configuration wherein a low oxygen-sensitivity ruthenium complex is sealed in an oxygen impermeable layer and over-coated with the HPTS-based CO₂ sensing layer.

15. A method as claimed in claim 13 wherein the quaternary ammonium hydroxide is selected from the group consisting of cetyl-trimetyl ammonium hydroxide (CTA-OH), tetra-octyl ammonium hydroxide (TOA-OH) or tetra-butyl ammonium hydroxide (TBA-OH) or other quaternary ammonium hydroxides.

16. A method as claimed in claim 13 wherein the pH indicator is selected from the group consisting pH indicators including hydroxypyrene trisulphonate (HPTS), fluorescein, rhodamine B and other fluorescent pH indicators.

17. A packaging medium having a combined CO₂ sensor and an O₂ sensor as claimed in claim 8 formed on a surface of the medium which will lie internally of the package when the package is formed.

18. A packaging medium as claimed in claim 17 wherein the sensors are formed on the packaging medium by a method selected from the group consisting of dip-coating, spin-coating, spray-coating, stamp-printing, screen-printing, ink-jet printing, pin printing, lithographic or flexographic printing or gravure printing.

19. A quality control method comprising reading a combined O₂/CO₂ sensor as claimed in claim 8, formed on the internal surface of a package, with an optical reader, and determining the levels of O₂ and CO₂ inside the package in relation to a control.

20. A method of screen-printing a combined O₂/CO₂ sensor as claimed in claim 8 onto a substrate comprising forcing the sensor sol through a mask or mesh and drying the substrate.

21. A method of ink-jet printing a combined O₂/CO₂ sensor as claimed in claim 5 onto a substrate comprising filling an ink reservoir of an ink-jet printer with sensor sol and printing the sensor sol onto the substrate using an ink-jet printer.

22. A method of forming a gas-sensitive sensor on a substrate comprising printing the substrate with a porous sol-gel matrix comprising a gas sensitive indicator.

23. A method as claimed in claim 22 wherein the gas sensitive indicator is an oxygen-sensitive luminescent complex.

24. A method as claimed in claim 22 wherein the gas sensitive indicator is a pH indicator and a long-lived reference luminophore.

25. A method as claimed in claim 22 wherein the gas sensitive indicator is a pH indicator and the substrate is further provided with separate oxygen impermeable layer comprising a long-lived reference luminophore.

26. A method as claimed in claim 22 wherein two gas sensors are formed on the substrate.

27. A method as claimed in claim 22 wherein the sensor is formed on the substrate by a method selected from the group consisting of dip-coating, spin-coating, spray-coating, stamp-printing, screen-printing, ink-jet printing, pin printing, lithographic or flexographic printing or gravure printing.

28. A method as claimed in claim 22 wherein the substrate is selected from the group consisting of plastics materials including surface-enhanced PET, PE and PET/PE laminates, adhesive plastic labels, rigid substrate materials including glass, Perspex/PMMA, polymer materials from which DVDs are made for example polycarbonate and other polymer materials, metal, and flexible substrate materials including acetate or flexible polymer materials, paper, optical fibre or glass/plastic capillary tubes.

29. A method as claimed in claim 22 wherein the sensor is a luminophore-based sensor.

30. A method as claimed in claim 22 wherein the sensor is a colorimetric-based sensor.

31. A substrate having a gas-sensitive sensor formed thereon wherein the sensor comprises a sol-gel matrix comprising a gas sensitive indicator and the sensor has been formed by printing.

32. A substrate as claimed in claim 31 wherein the substrate is selected from the group consisting of plastics materials including surface-enhanced PET, PE and PET/PE laminates, adhesive plastic labels, rigid substrate materials including glass, Perspex/PMMA, polymer materials from which DVDs are made for example polycarbonate and other polymer materials, metal, and flexible substrate materials including acetate or flexible polymer materials, paper, optical fibre or glass/plastic cap.
